(19) United States
(12) Patent Application Publication
(10) Pub. No.: US 2006/0009218 A1
(43) Pub. Date: Jan. 12, 2006

(54) Internet based cellular telephone service accounting method and system

(76) Inventor: Ronald Moss, Mount-Royal (CA)

Correspondence Address: WOMBLE CARLYLE SANDRIDGE & RICE, PLLC, P.O. BOX 7037, ATLANTA, GA, 30357-0037, US

(21) Appl. No.: 11/210,742

(22) Filed: Aug. 25, 2005

Related U.S. Application Data
(63) Continuation of application No. PCT/CA04/00266, filed on Feb. 25, 2004.
(60) Provisional application No. 60/449,404, filed on Feb. 25, 2003.

(51) Int. Cl. H04Q 7/20

(52) U.S. Cl. 455/435.1

(57) ABSTRACT

A method and a system for registering a wireless telephone user are provided. The method comprises providing subscriber identification data on wireless carrier on-line activation site; using, without re-keying, the subscriber identification data in and by at least one separate database, thereby eliminating double-entry of subscriber information. The system comprises a wireless carrier on-line activation site on which subscriber identification data can be provided; a data provider for providing data to the activation site; a data extractor for extracting the subscriber identification data from the activation site; at least one separate database receiving the identification data extracted by the data extractor and using the data; whereby double-entry of subscriber information is eliminated.

### CROSS-REFERENCE TO RELATED APPLICATIONS

This is a Continuation of International Application No. PCT/CA2004/000266, filed Feb. 25, 2004, which designated the United States, published as WO 2004/077862, and which claims priority to U.S. Provisional Application No. 60/449,404, filed Feb. 25, 2003. The contents of the aforementioned International Application and U.S. Provisional Application are incorporated by reference.

### FIELD OF THE INVENTION

The invention relates to point-of-sale and accounting systems. More specifically, it relates to customer subscriber information keyed in on wireless carrier on-line activation web sites and cellular retail stores accounting systems.

### BACKGROUND OF THE INVENTION

Personal cellular phones are becoming more and more popular. In addition to the business customers, teenagers and soccer moms are discovering the advantages of carrying a phone with them at all times.

When buying a new phone at a local cellular retail store, the customer chooses the device, the plan, the service provider and the accessories he wishes to buy. Promotions may be available, such as a free phone with the signing of a 2 year contract with the cellular airtime carrier service provider.

Once the customer is ready to purchase the phone and the plan, the salesperson needs to process the purchase and all the details specific to the purchase in two separate non-integrated computer systems and databases. The reason for this is that there is the initial requirement for the salesperson to enter all of the customer's personal information, cellular phone make, model and ESN (electronic serial number), billing information and credit information into a cellular activation system owned by and administrated by a cellular airtime carrier service provider. This process in and of itself is extremely laborious and time consuming.

To comply with this first requirement, the salesperson must therefore activate the cellular phone by contacting the service provider. In the early beginnings, a telephone call was made to the service provider customer service by the salesperson and the information about the customer, the serial number of the telephone and the plan chosen was discussed verbally. This led to multiple typographical errors and a long wait period for the customer. In some other instances, the setting up of the account was done via facsimile transmission or using an automated voicemail system.

As Internet evolved and secure transactions were made possible, some salespeople began using the service provider's web site to activate a new cellular phone. The information about the customer, the cellular phone and the plan chosen is keyed into the service provider's database through the web site interface while the customer waits. When all of the information is entered, the web site provides a confirmation number as well as a cellular phone number which will be assigned to the cellular phone.

Once the activation information has been successfully processed by the cellular airtime carrier, the salesperson is faced with having to key in all of the same information into a second database system. The activated cellular phone serial number and any other purchased items such as an extra battery are then manually keyed in to the accounting system owned and maintained by the cellular retail store. This is done for inventory and tax purposes and to provide the consumer with a receipt for the purchase. It also allows payment information to be entered. This second task of keying in the same information into the accounting system of the cellular retailer is obviously also time consuming and laborious and is clearly redundant.

Once both of these data entries are completed, the cellular phone number is programmed into the cellular phone by the salesperson and the number is added into the accounting system for future reference and warranty purposes. The cellular phone is then finally handed to the customer who can use it after a certain activation delay has occurred.

This process is obviously very long and repetitive. The customer must wait until all information is keyed into the systems twice before leaving the store. This causes long lines at the purchase counters and annoys customers.

The main technical problems with the carrier and dealer systems utilized to complete the cellular phone activation and sale are that these systems do not communicate with each other. They are always separate and apart from each other. In effect, they are disconnected. Because of this, consumers wait long periods of time to conclude their purchase and key common business critical information important to both the retailer and the cellular airtime carrier service providers for re-use in reconciliation of these transactions which is the core of the retailer and the cellular airtime carrier service providers ongoing relationship and revenue model is often mismatched. The problem is ongoing because the cellular airtime carrier service providers offer no solution to the retailers to solve this problem and there exists no technology to address and resolve this double data-entry problem.

### SUMMARY OF THE INVENTION

Accordingly, an object of the present invention is to overcome the drawbacks of the prior art.

A further object of the present invention is to provide a system to prevent re-keying of information during the activation of a cellular phone.

According to a first broad aspect of the present invention, there is provided a method for registering a wireless telephone user. The method comprises providing subscriber identification data on wireless carrier on-line activation site; using, without re-keying, the subscriber identification data in and by at least one separate database, thereby eliminating double-entry of subscriber information.

According to another broad aspect of the present invention, there is provided a system for registering a wireless telephone user. The system comprises a wireless carrier on-line activation site on which subscriber identification data can be provided; a data provider for providing data to the activation site; a data extractor for extracting the subscriber identification data from the activation site; at least one separate database receiving the identification data extracted by the data extractor and using the data; whereby double-entry of subscriber information is eliminated.

### BRIEF DESCRIPTION OF THE DRAWINGS

These and other features, aspects and advantages of the present invention will become better understood with regard to the following description and accompanying drawings wherein:

FIG. 1 comprises FIG. 1A and FIG. 1B and is, a detailed flow chart of the steps of the preferred embodiment of the present invention;

FIG. 2 comprises FIG. 2A to FIG. 2T and is an illustration of a form to be filled in on the carrier website with comments on how to fill it in;

FIG. 3 is an illustration of an invoice screen of the accounting system of the present invention; and

FIG. 4 is a block diagram of the main components of the present invention.

### DETAILED DESCRIPTION

While illustrated in the block diagrams as groups of discrete components communicating with each other via distinct data signal connections, it will be understood by those skilled in the art that the preferred embodiments are provided by a combination of hardware and software components, with some components being implemented by a given function or operation of a hardware or software system, and many of the data paths illustrated being implemented by data communication within a computer application or operating system. The structure illustrated is thus provided for efficiency of teaching the present preferred embodiment.

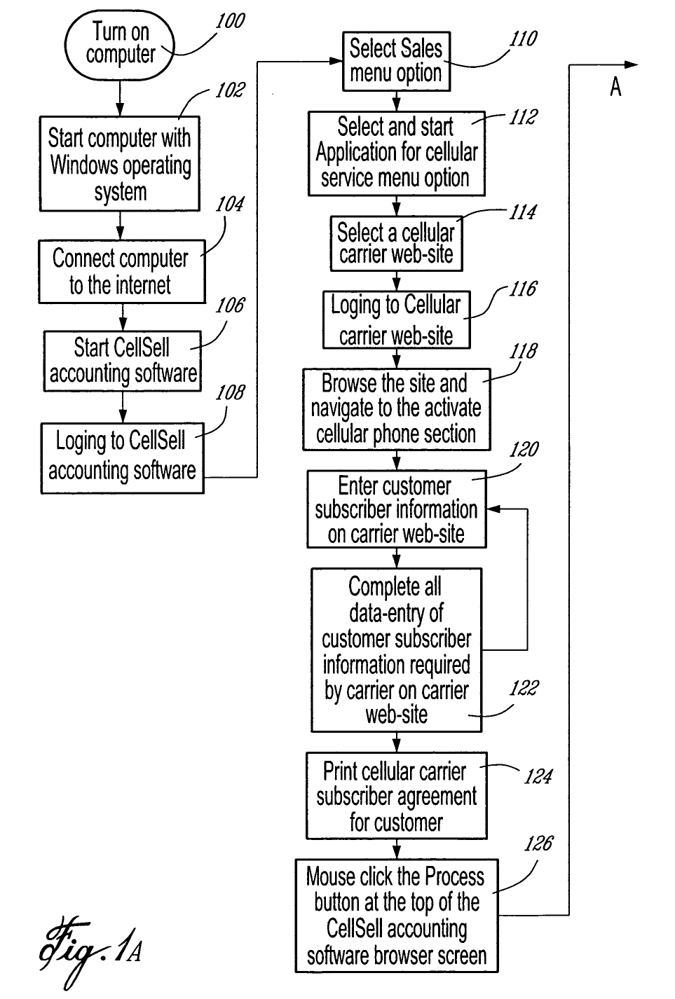

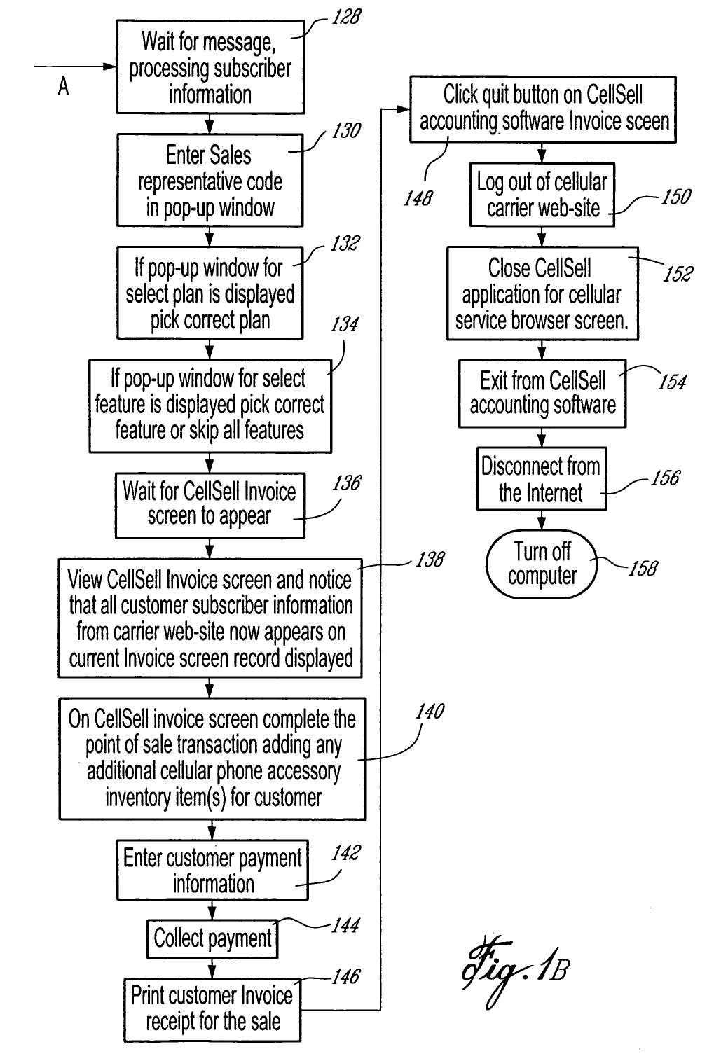

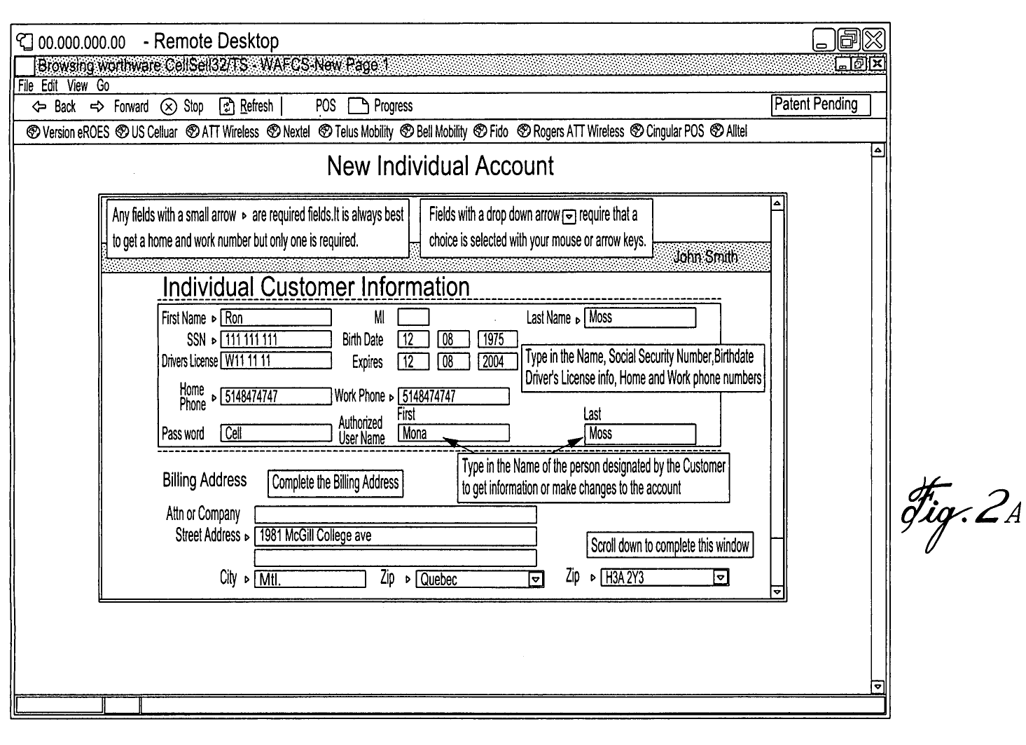

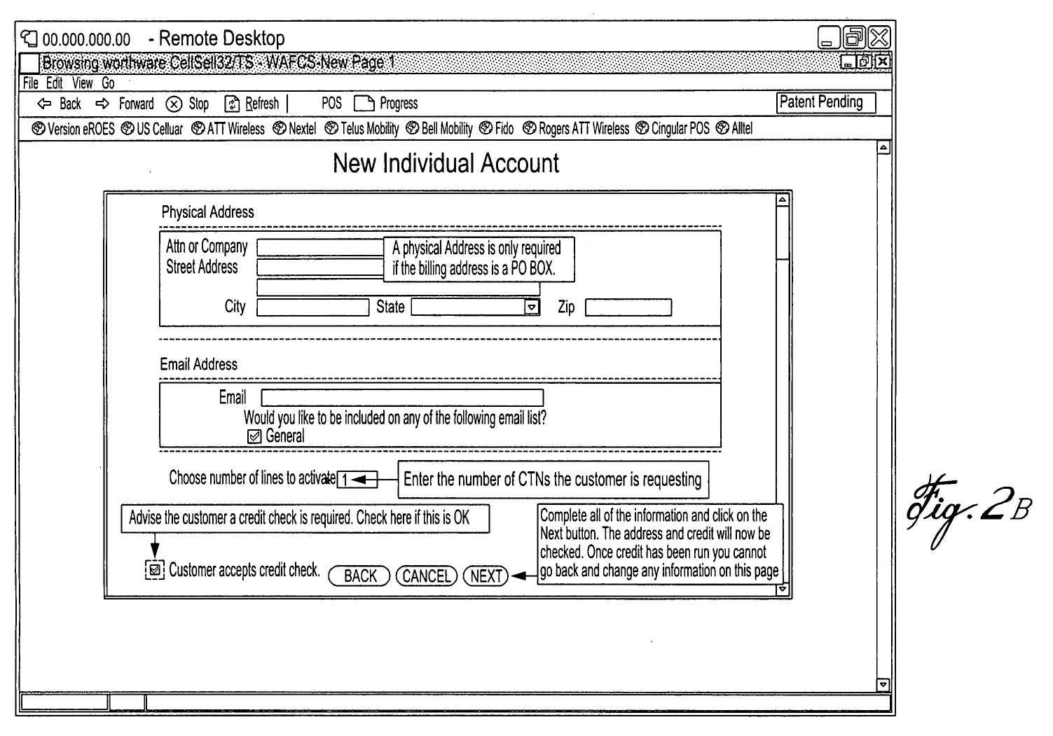

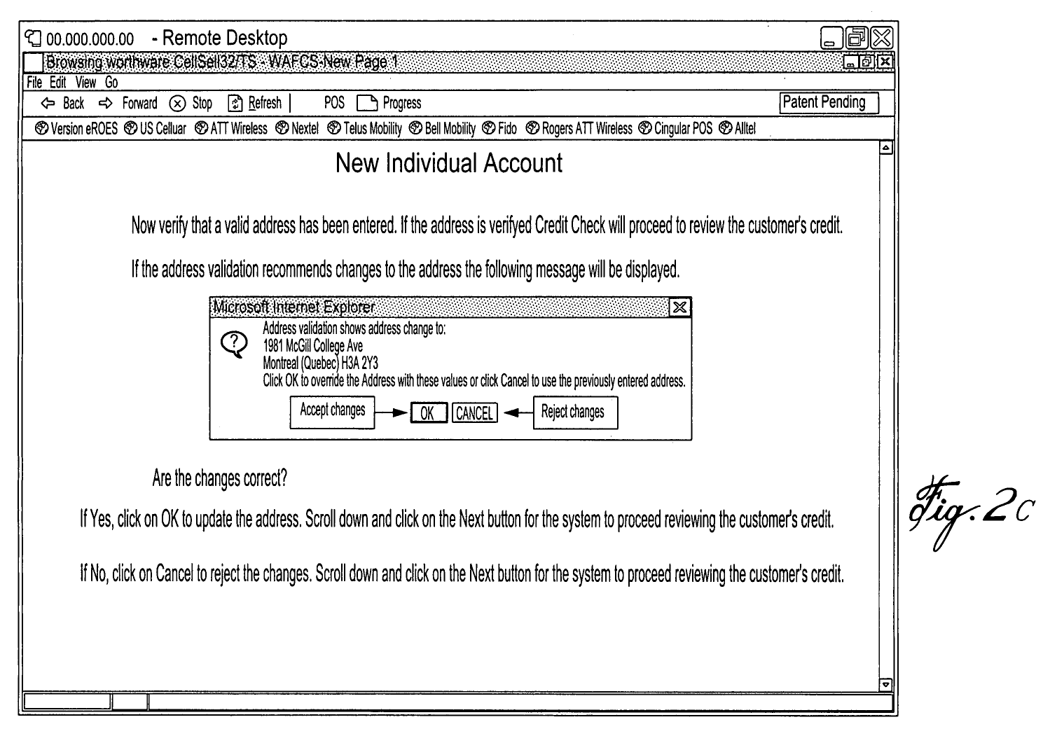

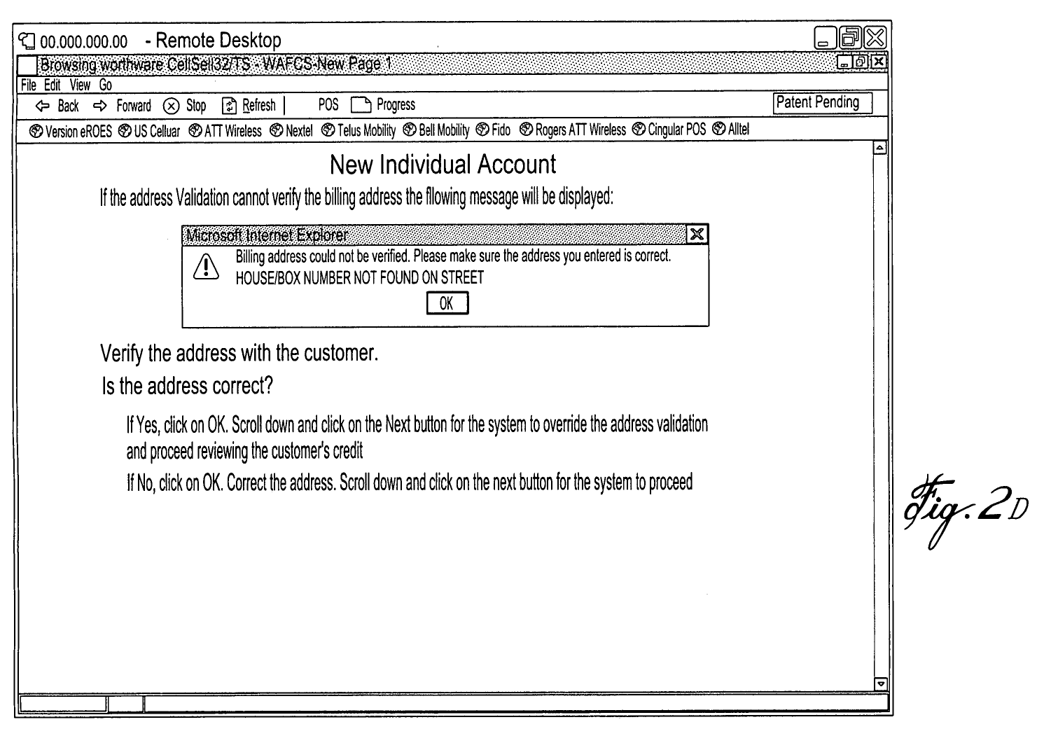

Referring to FIG. 1, the main steps of the preferred embodiment of the present invention will be detailed. A customer wants to buy a cellular phone as well as an additional battery. He chooses a cellular phone that fits his needs, for example a Motorola V120X model. He discusses the service provider plans with the salesperson and decides on a Telus plan. He is ready to make the purchase. He then approaches the purchase counter where the salesperson will enter all appropriate information and will activate his cellular phone.

The salesperson makes sure that the computer is turned on 100 and that the accounting software of the present invention is started 106. The computer should have access to the internet 104. Preferably, the computer runs on the Windows operating system 102. The salesperson logs into the accounting system 108 with his personal identification key and password. This serves to identify the salesperson for commission purposes.

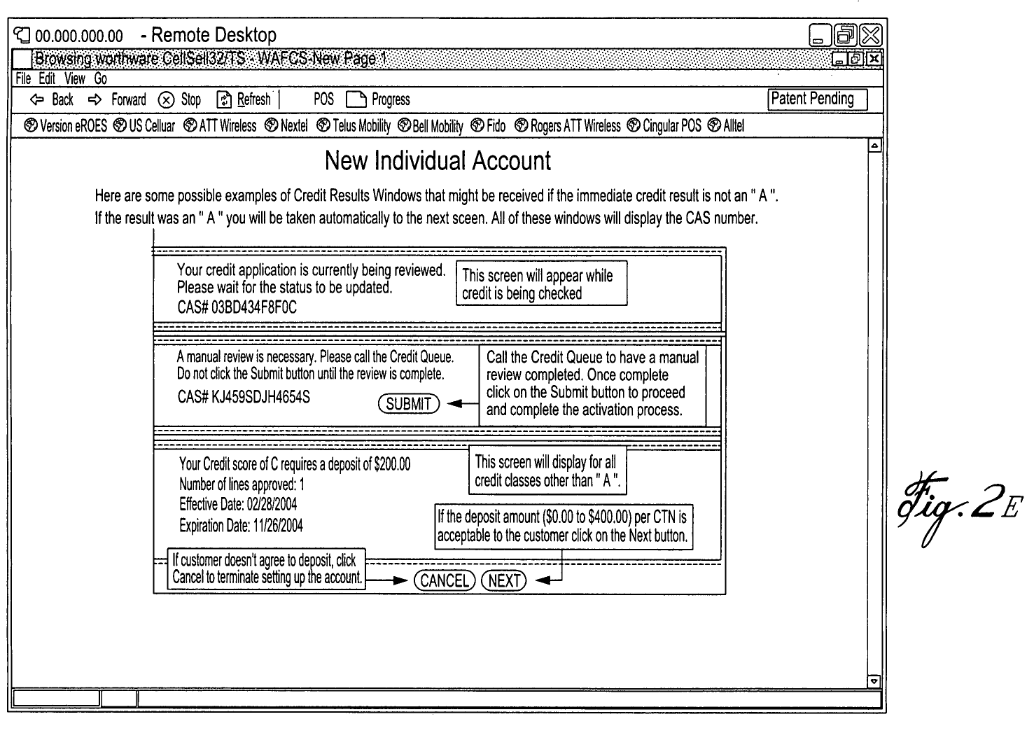

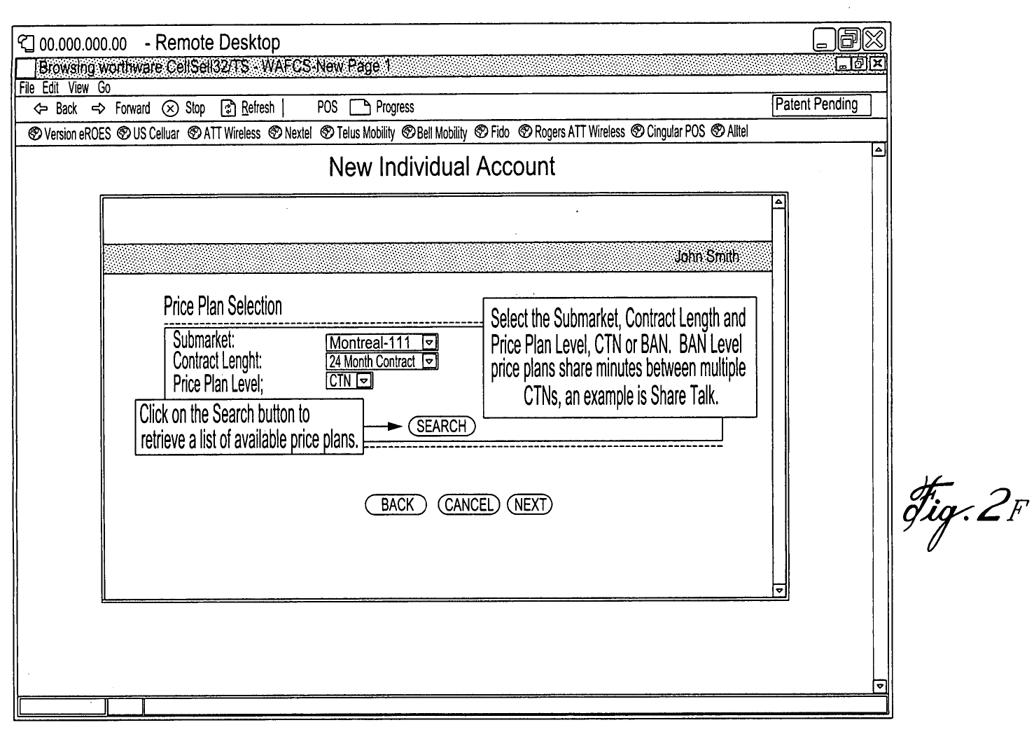

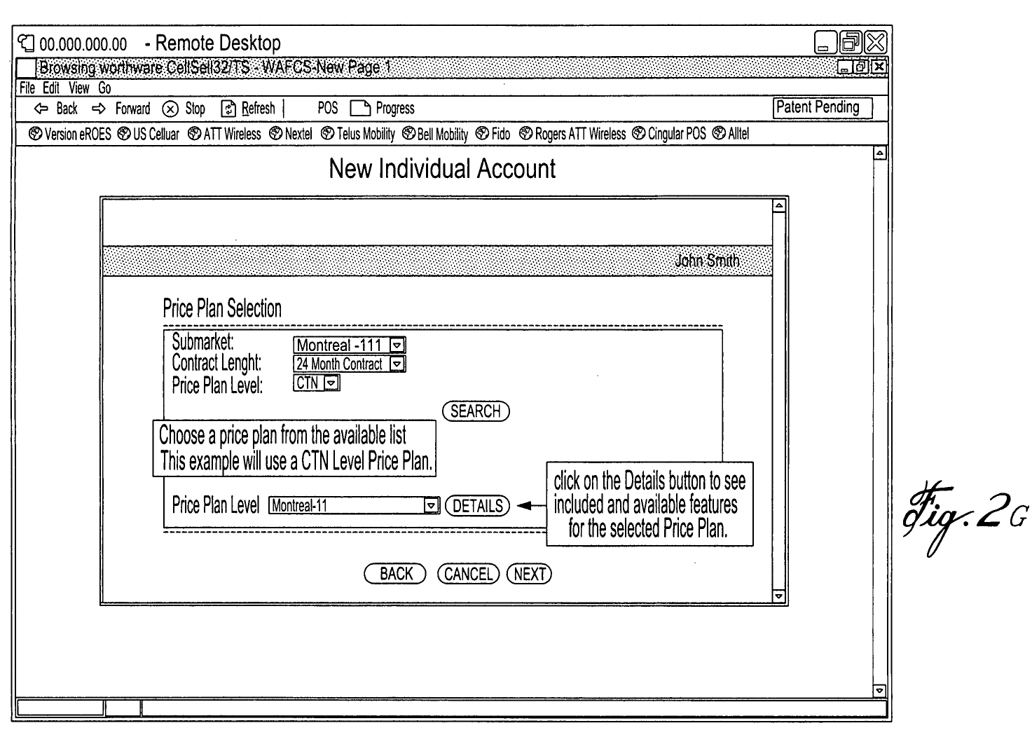

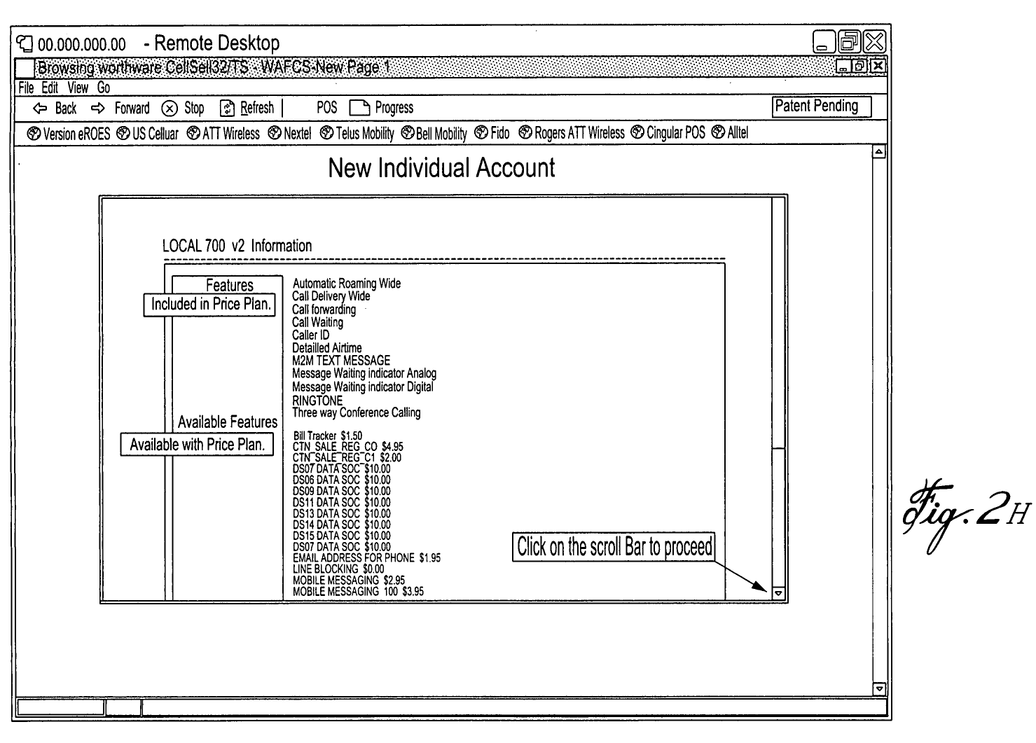

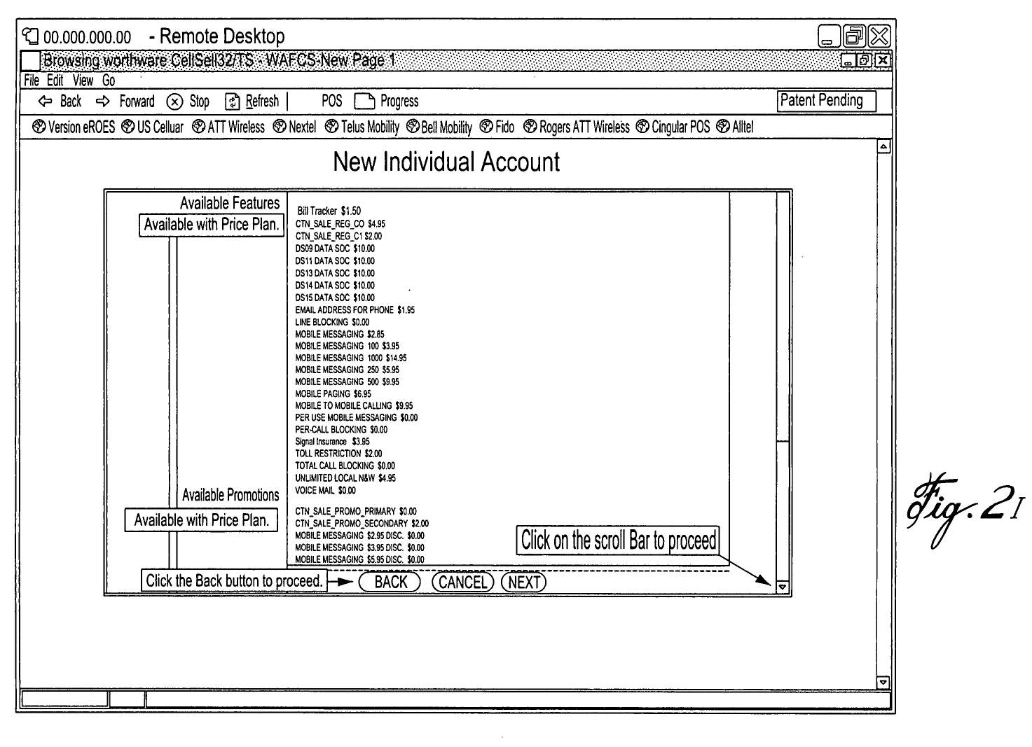

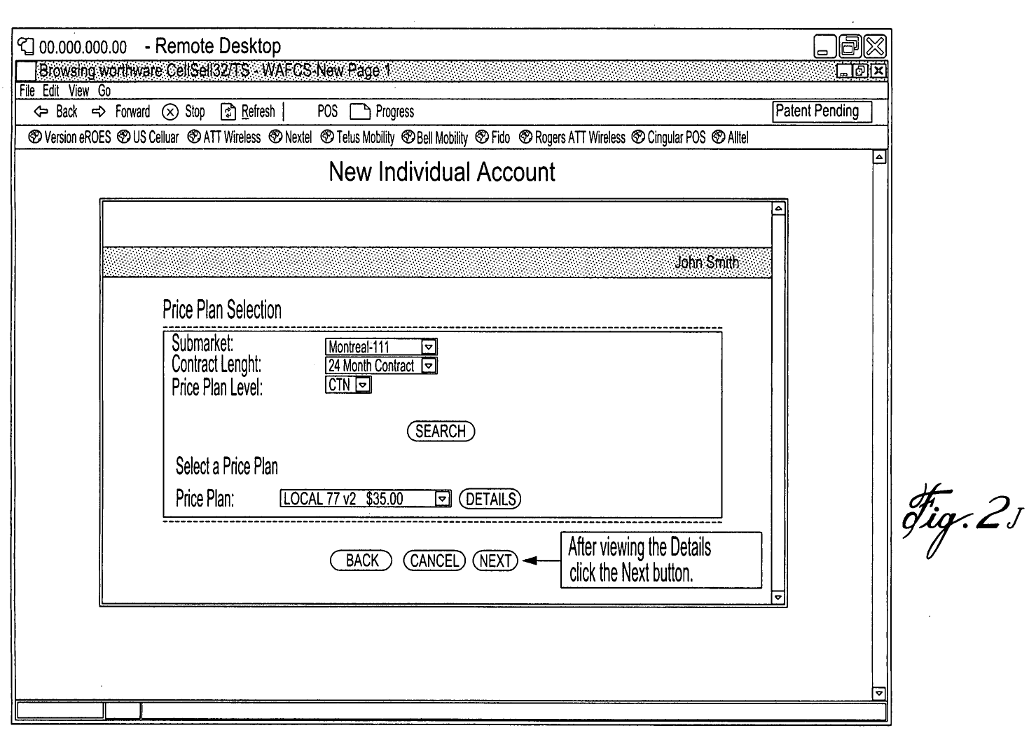

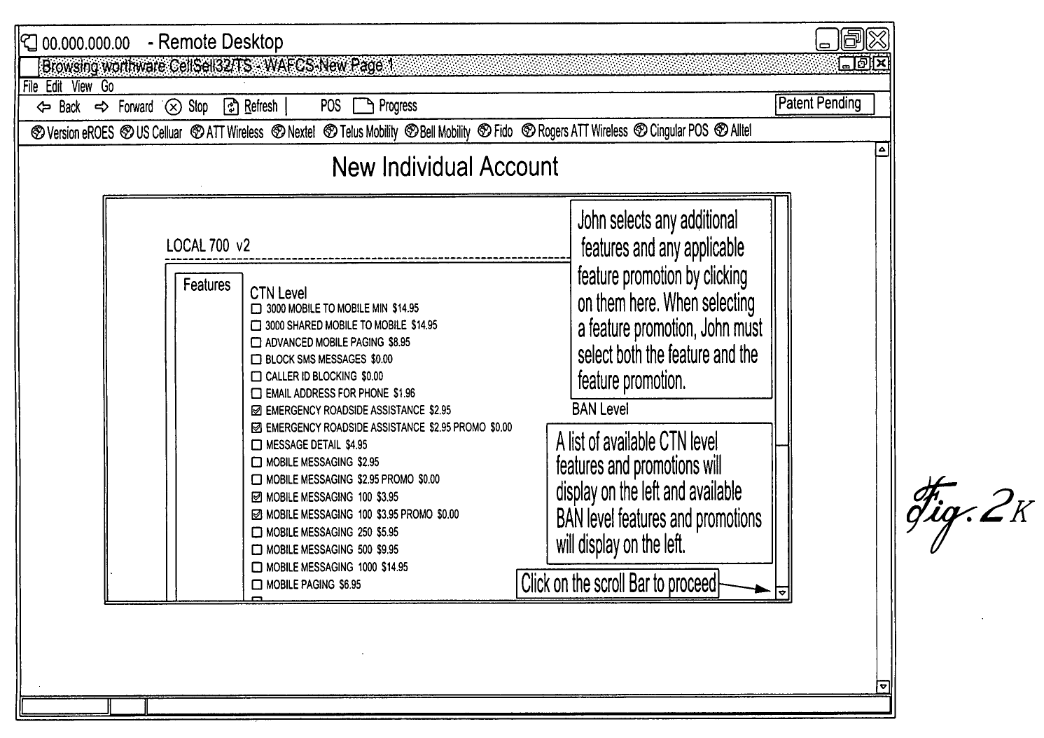

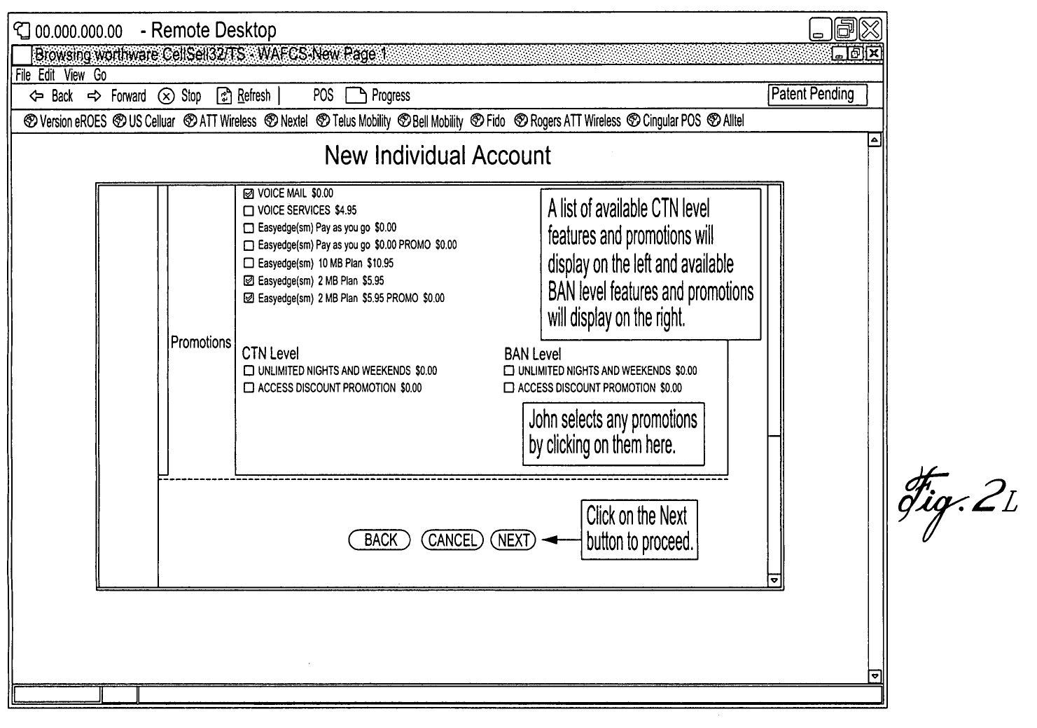

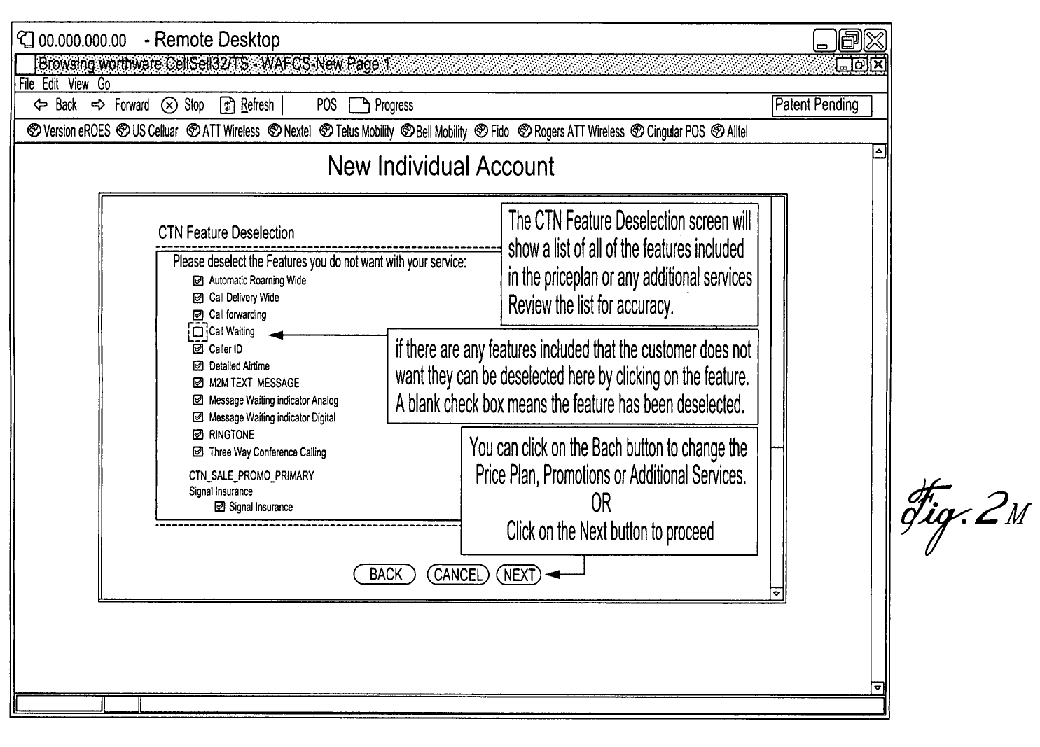

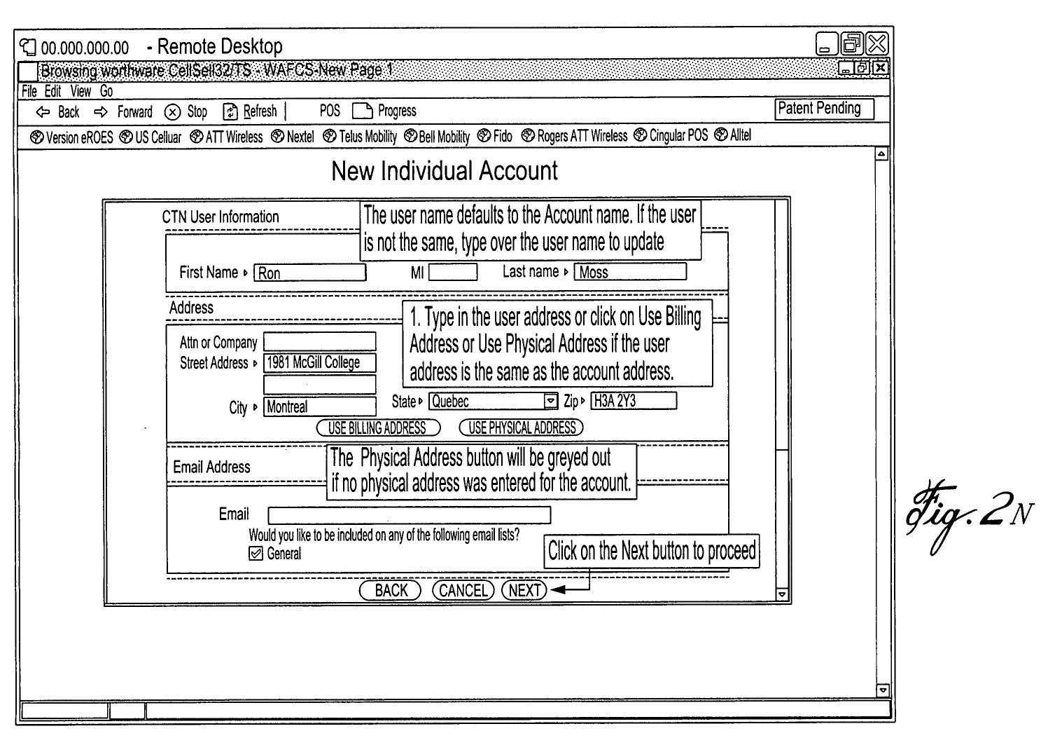

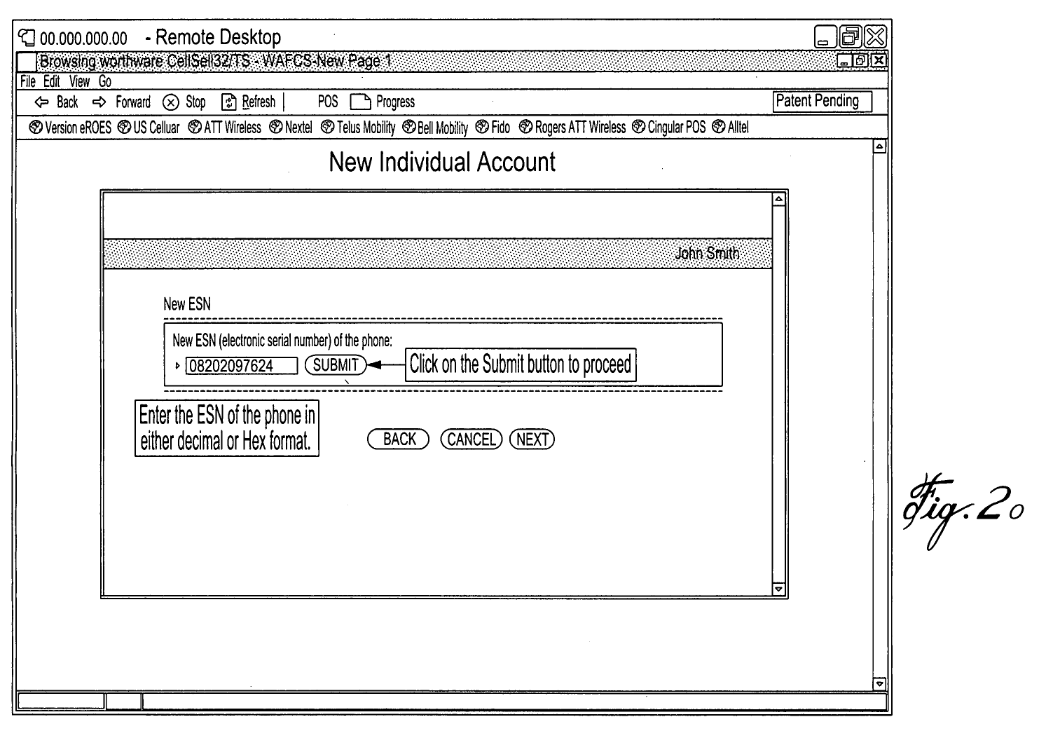

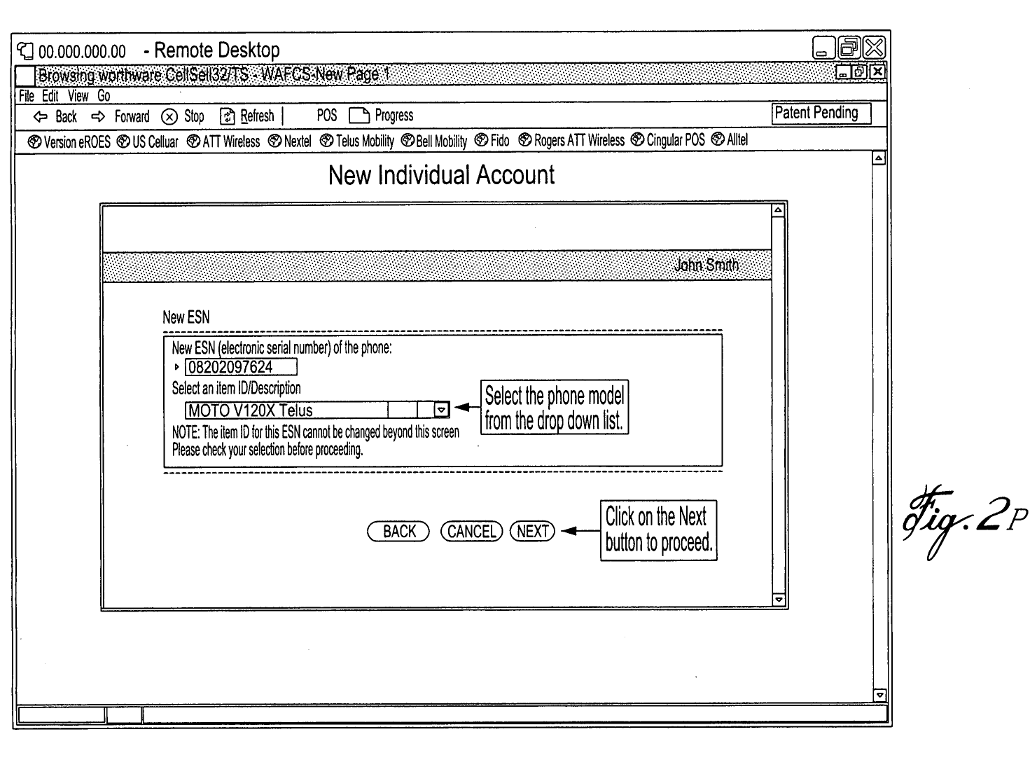

The salesperson chooses the “Sales” menu option 110 and selects and starts the application for the cellular service activation 112. A cellular service provider is chosen and links the salesperson to the service provider's website 114. The salesperson logs into the cellular carrier website, either using a personal identification key or using the identification of the store, depending on the carrier's requirements 116. If this key is identical to the login of the accounting system, it can be processed automatically. The salesperson navigates into the website to reach the “activation” section 118. The salesperson enters all of the customer subscriber information that is required by the carrier with input from the customer 120. This information is entered directly into the form provided by the carrier on its website. Refer to FIG. 2 for an example of the form provided by the carrier on its website. All of the information is entered until the data entry is finished 122. The subscriber agreement is directly prepared and displayed on the carrier website and is preferably printed for the customer 124. The carrier part of the activation is then finished and a cellular phone number is assigned to the customer and his new cellular phone using, preferably, the serial number of the cellular phone as an identification number.

FIG. 2 comprises FIG. 2A to FIG. 2T and is an illustration of a form to be filled in on the carrier website with comments on how to fill it in. FIG. 2A is the screen on which the personal information about the customer is entered, such as name, address, contact telephone numbers, authorized account managers, identification information, etc. FIG. 2B is where the physical address, if different from the billing address would be entered. The number of lines to activate is shown and a credit check verification is provided. FIG. 2C and FIG. 2D show potential results for an address verification. In FIG. 2C, the address is valid, in FIG. 2D, the address is invalid. FIG. 2E shows examples of results for the credit check. Depending on the result of the credit check, the transaction can be aborted.

FIG. 2F shows the Price Plan Selection. The submarket, contract length, price plan level are chosen. On FIG. 2G, the available price plans are selected from the availability list. The details of the example plan can be viewed on FIG. 2H and FIG. 2I. If more than one service plan is available for the chosen carrier, a window appears and requests choosing the correct plan 132. Once the details are viewed, the price plan is selected in FIG. 2J. Any additional features available with the plan can be chosen in FIG. 2K, FIG. 2L and FIG. 2M. If further features are chosen by the customer, the information about the features is entered in the accounting system 134. The features can be whether a voicemail is required, and whether the customer wants call display. The user information is defaulted to the customer information in FIG. 2N. If the user is not the same as the customer, the information needs to be modified.

The Electronic Serial Number (ESN) of the cellular phone is entered in FIG. 2O. The item description is selected to ensure proper assignment of the ESN to the actual telephone being purchased in FIG. 2P. The activation date is then processed and the appropriate number location and number group are chosen for the telephone number. It is possible to search for specific combinations of numbers in FIG. 2Q. A telephone number is assigned to the new cellular phone in FIG. 2R.

The salesperson then enters his representative code to ensure commissions dues are properly attributed 130, if he has not done so yet.

Once all the information has been processed, the information that has been entered is displayed for proof-reading purposes in FIG. 2S. If the information is correct, the information is validated and a customer service agreement is produced. This customer service agreement is typically printed for the customer in FIG. 2T.

The salesperson then clicks the “process” button in the browser screen 126 to transfer the information entered in the carrier web site into the accounting system database. A “processing subscriber information” message is preferably displayed while the information is transferred 128. A data extractor is used to extract the customer information from the carrier website. Since carrier activation websites are custom-made for each carrier, each field of the carrier website form can be linked to a database field in the accounting system and the information can be extracted.

A browser is used to access the carrier website and display it for the user. Once the user logs in to the carrier web site they are using the browser which is linked to the accounting software to represent the carrier web interface in one consolidated view. In reality, the user is working in both the carrier web-site and the accounting software for transactions, inventory and commissions simultaneously. When the carrier activation web-sites are modified, modifications are made to the extraction routines. The extraction process includes reading the html source in which the data is embedded and saving the pages in html format or text format, for example, reading this data and then processing, through data import procedures, the information contained in the saved pages and/or files into the accounting databases to eliminate double entry. It is important to note that the data extraction procedure is written for each carrier web-site, then integrated into the import procedures which tie in to the accounting software and customer database for the one step processing. The browser is an interface between the carrier web site and the accounting system and, while transmitting to the carrier the information it requested as a standard web browser would do, keeps a copy of the data entered in the form through the extraction routines and also transmits this information to the accounting system. The browser knows where to look on the carrier form to extract the information since it recreates it for the user using the carrier specific routines of the extraction module. There is a single point-of-sale interface presented to the salesperson even though data transmits between at least two independent databases. While the browser has a constant look-and-feel for all carriers, the extraction and capture routines differ.

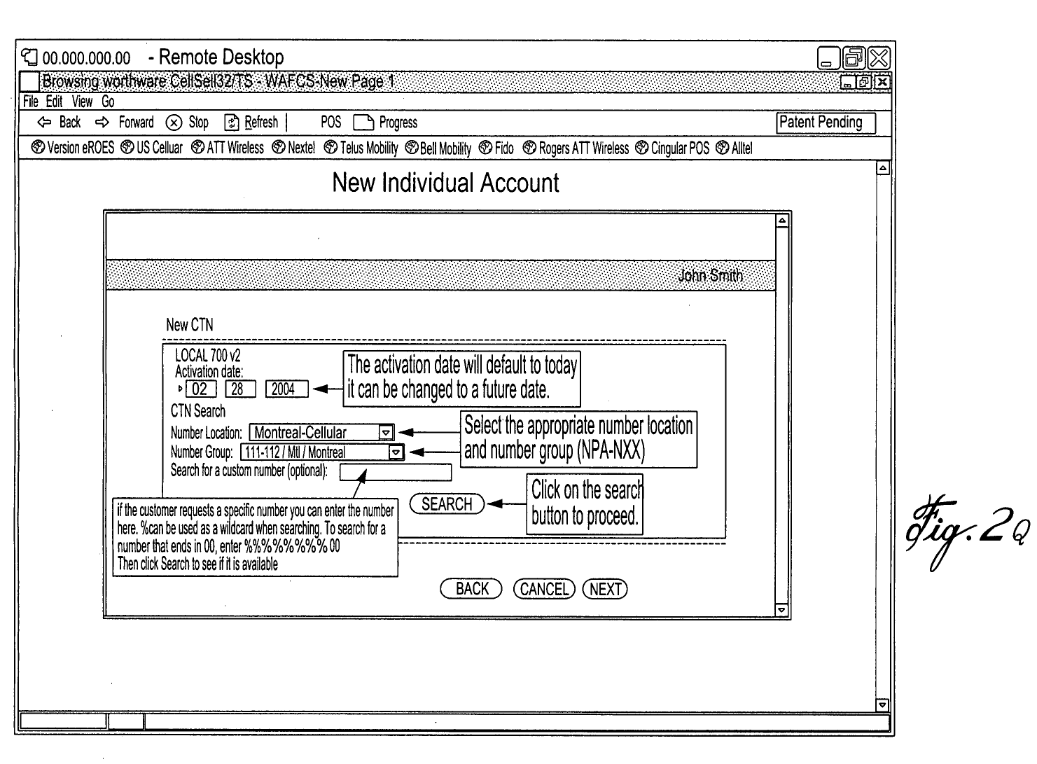

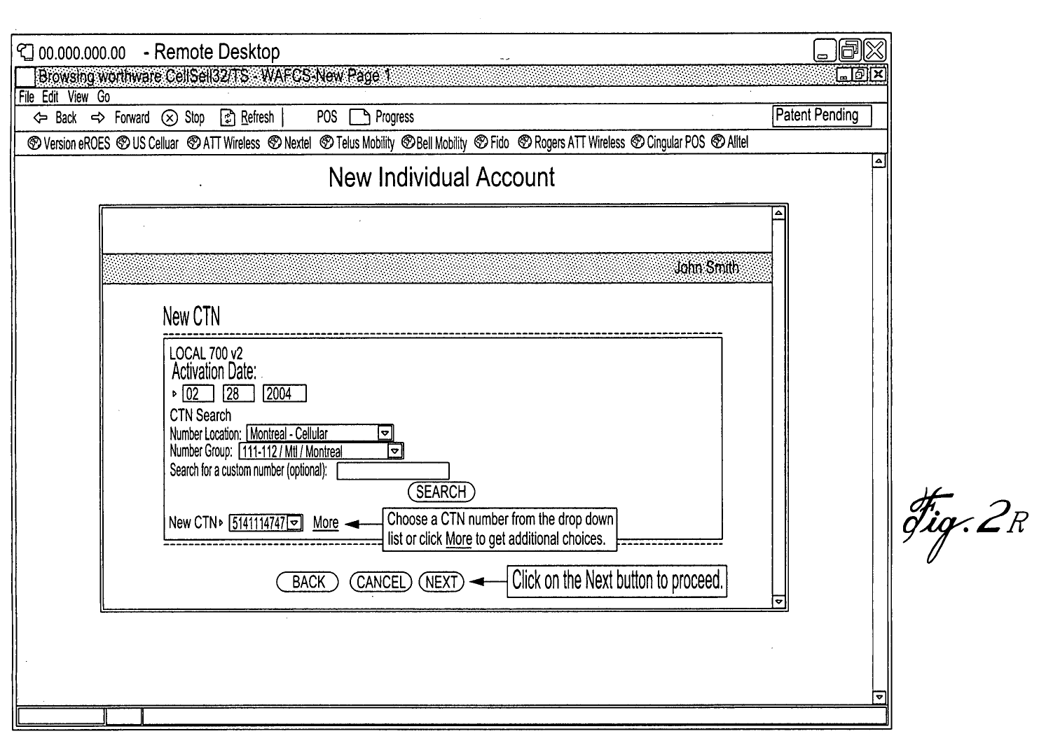

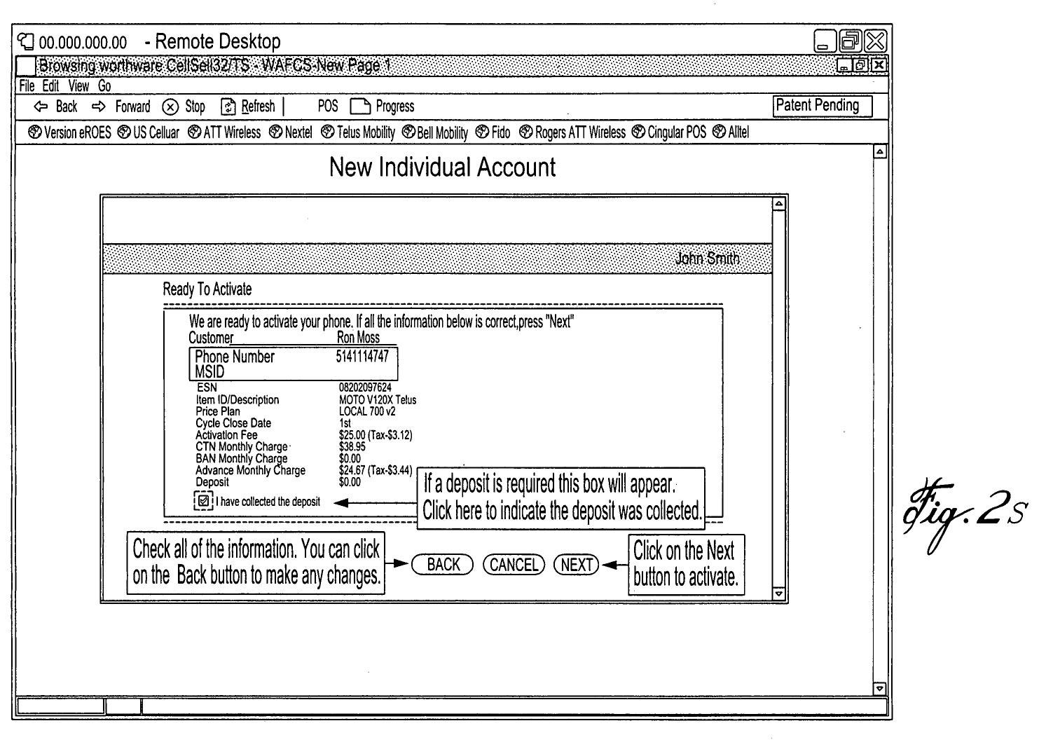

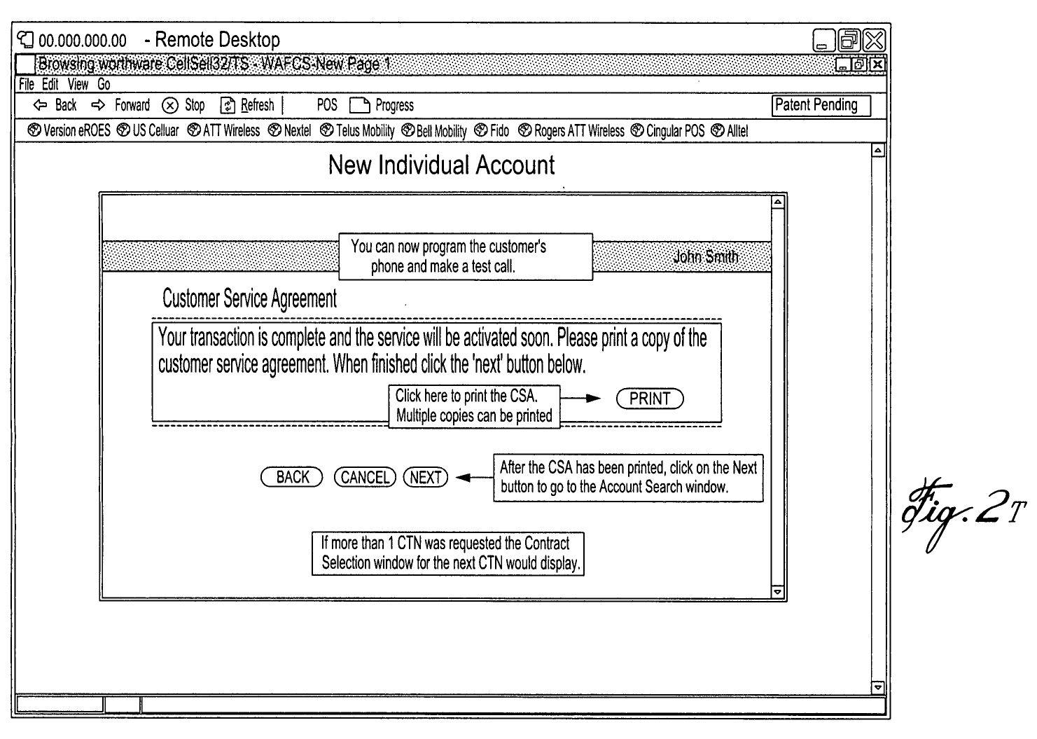

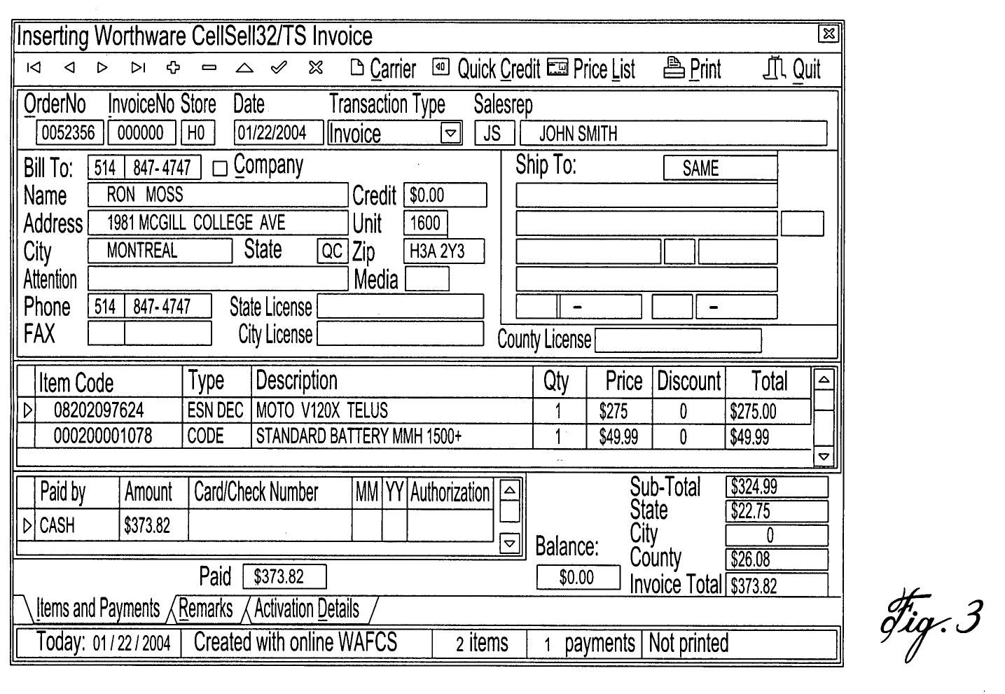

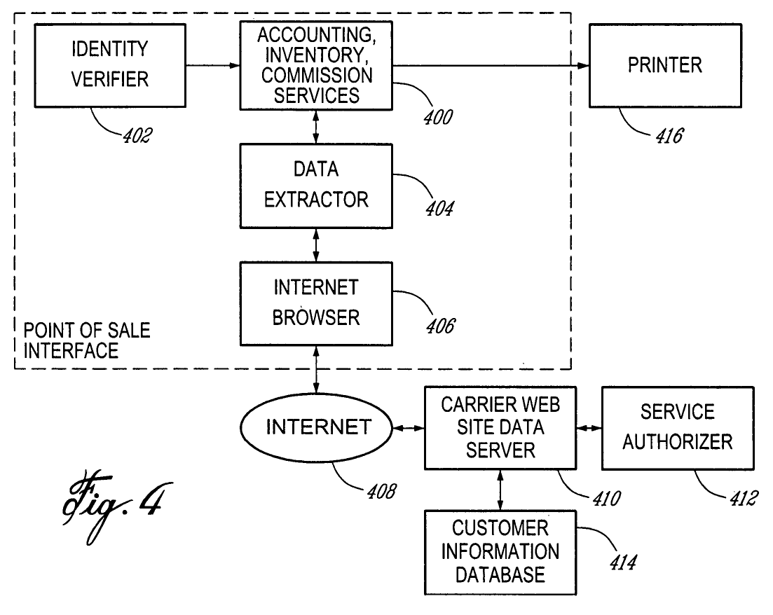

FIG. 4 shows a block diagram of the main components of the present invention. Accounting, inventory and commission services 400 are provided to the point-of-sale retailer. The identity of the salesperson is obtained and verified by the identity verifier 402. A single interface is used to present all of the information to the salesperson. When a new activation is to be made, the salesperson clicks on the appropriate carrier logo or name on the point-of-sale interface. This triggers a browser to open a web browsing window 406 and to turn on the data extraction algorithm 404 built for that carrier. The salesperson does not need to be aware that he is now surfing the carrier web site. All he needs to be aware of is that there is a form to fill in to conclude the transaction. The browser communicates with the carrier web site data server 410 via the internet 408.

The salesperson enters the information requested (see FIG. 2) and the information is stored in the Customer information database 414 at the Carrier premises. The service authorizer 412 verifies if the activation should be concluded and the carrier web site data server 410 reacts accordingly. The internet browser 406 presents all information obtained from the carrier to the salesperson and stores all data entered using the data extractor 404. Once activation of the cellular phone is completed, the salesperson clicks on the “process” button of the interface to retrieve the stored information. The information is filled in into the appropriate fields of the accounting, inventory and commission systems 400 and the re-keying of information is prevented. The sale is then completed. To the salesperson, the entering of information about the customer and the plan chosen is done once in the point-of-sale interface without a need to open and close multiple applications.

Preferably, the accounting system is able to retrieve updates from a main software provider server and these updates are self-executable programs which can update the extractor to re-assign fields from the website and modify the information extracted in case of a modification of the carrier form. These updates are either downloaded periodically or a query is sent to the software provider server each time the software is loaded up and the update is downloaded as soon as available. The type of change the carrier makes to their web-site impacts on the type of maintenance required to get the software back to one-step automation. If, for example, the format changes, the file format mappings are modified accordingly and are re-deployed, for example as a new DLL file which contains this new application logic. In other cases, an entirely new executable file replacing the existing point-of-sale interface with a new one which contains all of the newly modified algorithms and procedures is required to get the software back to one-step automation for the users.

In case the update has not yet taken place when the salesperson is ready to activate a phone, the “process” button will be disabled. The salesperson will then know that the transfer of information to the accounting system is not possible at this point and will contact the software provider to request and update. The salesperson will have to re-enter the information manually in the accounting system in these specific instances where an update was made to the carrier web site and the update to the software system is not yet available. As soon as the update becomes available, it would be downloaded or received by the salesperson and would be executed.

When all information is complete, the invoice is prepared from the accounting system 136. All information extracted from the carrier website appears on the invoice as if it had been re-entered by the salesperson 138. All accessories information are added on the invoice screen (such as shown in FIG. 3) 140 and payment information is entered 142.

In FIG. 3, an invoice screen is shown. The “Bill To” information was extracted from the carrier website, in this case, Telus. The inventory and accounting information is entered directly into the accounting system by the salesperson, for example, the item codes, or is automatically generated by the accounting system, for example, the order number and date. The items can also be inserted in the invoice by scanning their bar code with a bar code scanner.

Payment is obtained from the customer 144 and the invoice is printed 146. The invoice screen can be closed 148 and the salesperson can log out of the carrier web site 150. The accounting system browser screen is closed 152 and the accounting system is closed 154. The salesperson can disconnect the computer from the internet 156 and can turn off the computer at the end of the day 158.

In case of a repeat customer with the same carrier, most carrier websites recognize the customer using the previous cellular telephone number and can retrieve the personal information from their database. The information can then be updated, if need be, and the transaction can be continued. In case of a repeat customer at the dealer's store who wishes to use another carrier, the accounting system can retrieve the information from the accounting system and push it into the carrier website form instead of the opposite.

In case a store owner owns more than one store, the accounting system can be networked to allow a common inventory and clientele list to be built.

It should be noted that the present invention can be carried out as a method, can be embodied in a system, a computer readable medium or an electrical or electro-magnetical signal.

It will be understood that numerous modifications thereto will appear to those skilled in the art. Accordingly, the above description and accompanying drawings should be taken as illustrative of the invention and not in a limiting sense. It will further be understood that it is intended to cover any variations, uses, or adaptations of the invention following, in general, the principles of the invention and including such departures from the present disclosure as come within known or customary practice within the art to which the invention pertains and as may be applied to the essential features herein before set forth, and as follows in the scope of the appended claims.

What is claimed is:

1. A method for registering a wireless telephone user in a retailer database for use by a retailer management system, comprising:
providing subscriber identification data concerning said user in fields of a wireless carrier on-line activation site;
extracting said subscriber identification data from said fields; and
importing said extracted subscriber identification data in said retailer database.

2. The method of claim 1, wherein said providing comprises entering the data in a form on said site.

3. The method of claim 1, wherein said providing comprises retrieving from a customer database of said wireless carrier.

4. The method of claim 1, wherein said extracted data is implemented in an accounting system of a wireless telephone retailer.

5. The method of claim 1, wherein said carrier online activation site is accessed through said retailer management system.

6. The method of claim 5, wherein said retailer management system comprises a web browser.

7. The method of claim 1, wherein said extracting is customized for the wireless carrier.

8. A system for registering a wireless telephone user in a retailer database, comprising:
a wireless carrier on-line activation site having fields in which subscriber identification data concerning said user can be provided;
a data provider for providing data to said activation site;
a data extractor for extracting said subscriber identification data from said fields;
a data importer for importing said extracted data in said retailer database; and
a retailer management system using said imported data.

9. The system of claim 8, wherein said activation site comprises a form.

10. The system of claim 8, wherein said data provider retrieves said identification data from a customer database of said wireless carrier.

11. The system of claim 8, wherein said retailer management system is an accounting system for a wireless telephone retailer.

12. The system of claim 8, wherein said data provider is a keyboard connected to a computer communicating with said activation site.

13. The system of claim 8, wherein said carrier online activation site is accessed through said retailer management system.

14. The system of claim 13, wherein said retailer management system comprises a web browser.

15. The system of claim 8, wherein said data extractor is customized for the wireless carrier.
